(19) United States
(12) Patent Application Publication
(10) Pub. No.: US 2004/0219363 A1
(43) Pub. Date: Nov. 4, 2004

(54) Carbon black pellets

(76) Inventors: Andreas Schuch, Koln (DE); Didier Bidet, Bruhl (DE)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/795,857

(22) Filed: Mar. 8, 2004

(30) Foreign Application Priority Data
Mar. 7, 2003 (DE) 103 09 957.3

(51) Int. Cl. B32B 9/00

(52) U.S. Cl. 428/408; 264/140; 264/349

(57) ABSTRACT

A method for producing carbon black pellets in a ring layer mixing granulator where the feed amount of unpelletized carbon black is kept constant and the water is dispensed via two nozzle holders positioned as close as possible to the inlet, each with two nozzles, where the spray cones make an angle between 10 and 90° to the direction of flow of the carbon black, at a pressure of 3-5 bar measured at the nozzles. Carbon black pellets are disclosed with an oil absorption number greater than 100 ml/100 g and an oil absorption number of the pressed carbon black greater than 78 ml/100 g, where the pellet fraction with a diameter greater than 2.5 mm is less than 3.5 wt %, the pellet fraction with a diameter of 0.71-1.0 mm is greater than 22 wt %, and the individual pellet hardness of the fraction with the 0.71-1.0 mm diameter is between 7.0 and 25.0 g. Also disclosed are carbon black pellets with an oil absorption number less than 90 ml/100 g, and an oil absorption number of the pressed carbon black less than 78 ml/100 g, where the pellet fraction with a diameter of 0.71-1.0 mm is less than 30 wt % and the individual pellet hardness of the fraction with the 0.71-1.0 mm diameter is between 7.0 and 25.0 g. The carbon black pellets can be used in polymer and rubber mixtures, paints, dyes or pigments.

### INTRODUCTION AND BACKGROUND

The present invention relates to carbon black pellets, a method for producing them, and their use.

Mainly granulated products, which are frequently called carbon black granulate, beaded carbon black or pelletized carbon black, are used in the processing of carbon blacks. Granulation is carried out differently depending on the structure and the surface of the carbon black. For instance, carbon blacks with low structure and low surface agglomerate easier than carbon blacks with high structure and low surface.

As is known, two different methods are used industrially for carbon black granulation: wet granulation in a pelletizing machine followed by drying, and dry granulation in a pelletizing drum. Both methods have distinctly different process parameters, which are closely connected with the physical operations in the relevant agglomeration and with the resulting pellet properties.

Granulators with toothed shafts are used as pelletizing machines for wet granulation. They consist of a horizontal fixed tube (stator) with a toothed shaft rotating in the tube. Between the axis of the toothed shaft and the tube wall there is pelletizing space that is available for the granulation. The carbon black is transported in the pelletizing space from the inlet at one end of the tube to the outlet at the other end of the tube by the rotating toothed shaft. The agglomeration takes place by the rolling of the carbon black over the standing tube wall.

In the pelletizing machine the powdered carbon black is intensively mixed with water, optionally with the addition of a binder. The wet pellets are then dried in an additional process step; see DE-AS (German published patent application) 1 264 412, U.S. Pat. No. 3,607,086, U.S. Pat. No. 3,787,161, U.S. Pat. No. 4,222,727.

The hardness of the carbon black pellets that can be obtained by the known wet granulation lies in the range between 0.1 and 0.3N for pellet diameters between 1.4 and 1.7 mm, if binders are not used.

Additives can be used to increase the hardness and/or to improve the dispersibility of the pellets both in the wet and dry granulations.

The known carbon black pellets have the disadvantage that the hardness, shape and/or structure of pellets is so unsatisfactory that the processability (dispersibility and rate of incorporation) and/or the flow and storage properties are poor.

The hardness of a pelletized carbon black should be as low as possible so that the pellets quickly break up and rapid and good dispersion is achieved. However, the flow and storage properties deteriorate with decreasing pellet hardness. Because of the lower pellet hardness more fine fraction is formed due to abrasion and breakage in flow or transport operations, which has as a consequence transport problems and poorer or slower incorporation (dispersion and incorporation) of carbon black pellets into the medium that is used.

The task of this invention is to make available carbon black pellets that have good flow and storage properties and are soft enough to incorporate and to disperse.

### SUMMARY OF THE INVENTION

The present invention provides a method for producing carbon black pellets that is characterized by the fact that in a ring layer mixing granulator the feed amount of unpelletized carbon black is kept constant and water is sprayed at a pressure of 3-5 bar (measured at the nozzles) via two nozzle holders positioned as close as possible to the inlet, each with two nozzles, where the spray cones of the nozzles make an angle between 10 and 90°, preferably between 30 and 60°, to the direction of flow of the carbon black.

The unpelletized carbon black can be fed to the inlet of the ring layer mixing granulator by means of a conveyor screw. The carbon black throughput or the throughput amount of the ring layer mixing granulator is thus equal to the transport rate of the conveyor screw and thus can be adjusted in wide limits. The filling amount and residence time can be lengthened by raising the outlet above the inlet. The angle that results between the axis of the granulator and the horizontal can be changed between 0 and 15°.

The filling amount and residence time can be affected further by the rotary speed of the toothed shaft. For the same carbon black feed (constant carbon black throughput) the filling amount and residence time decrease in proportion to each other with increasing rotary speed.

During pelletizing the stator of the ring layer mixing granulator can be heated to a temperature between 20 and 150° C., preferably to 80 to 120° C., in order to largely prevent sticking of the carbon black to the wall of the stator.

The carbon black pellets from the ring layer mixing granulator can then be dried. The drier temperature can be between 100° and 250° C., preferably between 150° and 200° C. The temperature of the carbon black pellets at the drier outlet can be between 30° and 100° C., preferably between 40° and 70° C.

### BRIEF DESCRIPTION OF DRAWINGS

The present invention will be further understood with reference to the accompanying drawings, wherein:

FIG. 1 is a schematic representation of a ring layer mixing granulator with a toothed shaft for carrying out the invention; and

FIGS. 2-10 are graphs of dense flow transport tests showing weight of carbon black transported (left hand axis) with time, and transport pressure (right hand axis) with time.

### DETAILED DESCRIPTION OF INVENTION

In principle, all types of carbon blacks can be granulated with the method in accordance with the invention. Furnace blacks, flame blacks, gas blacks, channel black, thermal black, acetylene black, plasma black, inversion black, which is known from DE 195 21 565, Si-containing carbon blacks, which are known from WO 98/45361 or DE 19613796, or metal-containing blacks, which are known from WO 98/42778, arc blacks, and carbon-containing materials that are byproducts of chemical production processes, can be used. Preferably, carbon blacks with BET surfaces between 10 and 200 m2/g can be used.

Binders can be added to the water that is sprayed in. Molasses, lignin sulfonates and many other substances by themselves or in combination with each other can be added as binders. The binder can be used in a concentration between 0.5 and 5 wt %. For carbon black pellets with an oil absorption number greater than 100 ml/100 g the binder can be used in a concentration between 0.5 and 1.5 wt %. For carbon black pellets with an oil absorption number less than 90 ml/100 g the binder can be used in a concentration between 1.5 and 2.5 wt %.

Depending on the oil absorption number and the oil absorption number of the pressed carbon black, there are two different groups of carbon black pellets in accordance with the invention:

One embodiment of the invention comprises carbon black pellets with an oil absorption number greater than 100 ml/100 g and an oil absorption number of the pressed carbon black greater than 78 m 100 g, which are characterized by the fact that the pellet fraction with a diameter greater than 2.5 mm is less than 3.5 wt %, preferably less than 2.0 wt %, the pellet fraction with a diameter of 0.71-1.0 mm is greater than 22 wt %, preferably greater than 25 wt %, and the individual pellet hardness of the fraction with the 0.71-1.0 mm diameter is between 7.0 and 25.0 g, preferably between 8.0 and 20.0 g.

Another embodiment of the invention comprises carbon black pellets with an oil absorption number less than 90 ml/100 g and an oil absorption number of the pressed carbon black less than 78 ml/100 g, which are characterized by the fact that the pellet fraction with a diameter of 0.71-1.0 mm is less than 30 wt %, preferably less than 25 wt %, and the individual pellet hardness of the fraction with the 0.71-1.0 mm diameter is between 7.0 and 25.0 g, preferably between 8.0 and 20.0 g.

The carbon black pellets can have a BET surface of less than 70 m2/g, preferably less than 50 m2/g. The moisture content of the undried carbon black pellets can be between 35 and 60 wt %.

The carbon black pellets in accordance with the invention can be used in polymer mixtures such as rubber and plastics, paints, dyes, pigments and many other usages of carbon black.

Another feature of the present invention resides in carbon black mixtures that are characterized by the fact that they contain rubber, the carbon black pellets in accordance with the invention, optionally precipitated silica, and/or other rubber auxiliaries.

Besides natural rubber, synthetic rubbers are also suitable for the preparation of rubber mixtures in accordance with the invention. Preferred synthetic rubbers are, for example, described in Hofmann, Rubber Technology, Genter Verlag, Stuttgart, 1980. They include, among others:

Polybutadiene (BR),

Polyisoprene (IR),

Styrene/butadiene copolymers with styrene contents of 1-60, preferably 5-50 wt % (SBR),

Isobutylene/isoprene copolymers (IIR),

Butadiene/acrylonitrile copolymers with acrylonitrile contents of 5-60, preferably 10-50 wt % (NBR),

Ethylene/propylene/diene copolymers (EPDM),

and mixtures of these rubbers.

The rubber mixtures in accordance with the invention can contain other rubber auxiliary products such as, among others, reaction accelerators, retardants, antiaging agents, stabilizers, processing auxiliaries, plasticizers, waxes, metal oxides, and activators like triethanolamine, polyethylene glycol or hexanetriol, which are known to the rubber industry.

The rubber auxiliaries can be used in the usual amounts, which are governed among other things by the intended purpose. The usual amounts are, for example, amounts from 0.1-50 wt % with respect to the rubber.

Sulfur, organic sulfur donors or radical forming agents can serve as crosslinking agents. The rubber mixtures in accordance with the invention can, moreover, contain vulcanization accelerators. Examples of suitable vulcanization accelerators are mercaptobenzthiazoles, sulfenamides, guanidines, thiurams, dithiocarbamates, thioureas, and thiocarbonates.

The vulcanization accelerators and crosslinking units can be used in amounts of 0.1-10 wt %, preferably 0.1-5 wt %, with respect to the rubber.

The mixing of the rubbers with the carbon black pellets in accordance with the invention, optional rubber auxiliaries and optionally other fillers can be carried out in the conventional mixing units such as rolls, internal mixers and mixer extruders. Usually such rubber mixtures are prepared in internal mixers, where first the rubbers, the carbon black pellets in accordance with the invention, optionally the silica, and the rubber auxiliaries are mixed together at 100-170° C. in one or more successive thermomechanical mixing steps. Here the sequence of addition and the time point of addition of the individual components can have a decisive effect on the properties of the resulting mixture. The rubber mixture obtained in this way is then usually mixed with the crosslinking chemicals in an internal mixer or on a roll at 40-110° C. and processed to the so-called raw mixture for the subsequent process steps such as molding and vulcanization.

The vulcanization of the rubber mixtures in accordance with the invention can take place at temperatures of 80-220° C., preferably 130-180° C., optionally under pressure of 10-200 bar.

The rubber mixtures in accordance with the invention are suitable, among other things, for preparation of molded articles, for example, for the preparation of pneumatic tires, tire treads, cable jackets, hoses, drive belts, conveyor belts, roll coatings, tires, shoe soles, sealing rings, profiles and shock absorption elements.

The carbon black pellets in accordance with the invention have the advantage that excellent flow and storage behavior is enabled in spite of the lowered individual pellet hardness.

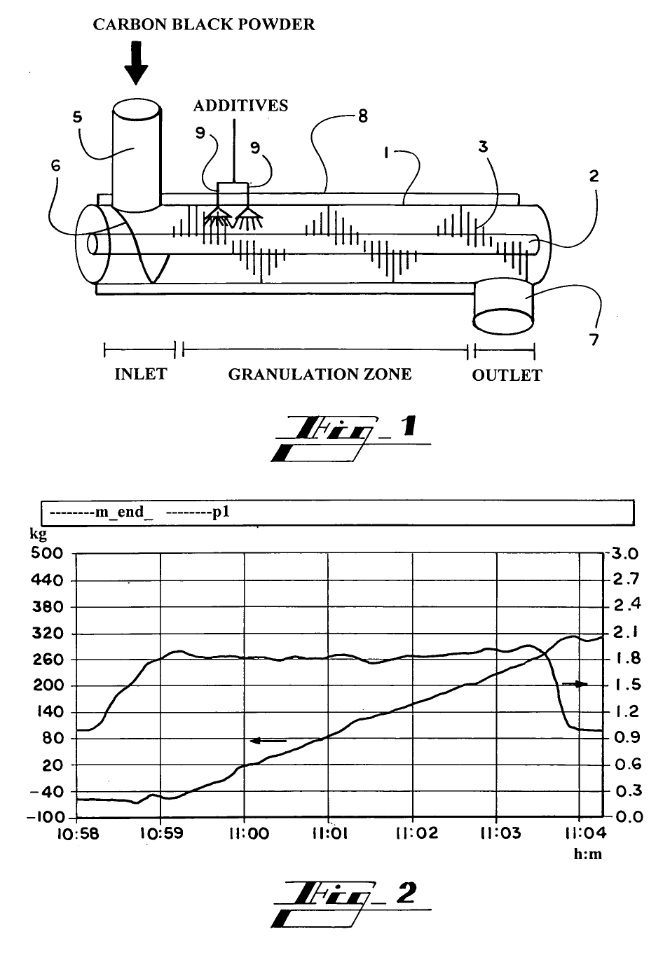

Ring layer mixing granulator with toothed shaft for carrying out the method in accordance with the present invention is schematically depicted in FIG. 1. The granulator comprises a horizontal fixed tube 1, the stator, and a rotating toothed shaft 2 axially arranged in it, with the plurality of helically arranged teeth 3. The pelletizing space of the granulator is situated between the toothed shaft 2 and stator 1. The carbon black is fed to the ring layer mixing granulator at inlet 5. In the region of the inlet there is a conveyor screw 6 on the toothed shaft, which conveys the unpelletized carbon black in the axial direction toward the outlet 7. Stator 1 is designed to be double walled and allows temperature control of the stator wall with the help of a liquid 8. Along the stator there are through-holes, through which spray nozzles 9 for additives can be inserted.

### EXAMPLE 1

Preparation of Carbon Black Pellets

The comparison carbon blacks are prepared in a pelletizing machine with a toothed shaft, where the pelletizing teeth (or pins) are arranged in three helixes around the toothed shaft. The rotary speed is kept constant at 220 rpm. The input of water takes place through an axial lance with six orifices.

Various types of carbon blacks in accordance with the invention are granulated with the ring layer mixing granulator as in FIG. 1. The granulator that was used for all of the examples in accordance with the invention (RMG 600WL, Rubert Mixing Technology KG) has a length of 3000 m and an inside diameter of 515 mm. The granulator is tempered with superheated water at 110° C.

The carbon blacks in accordance with the invention are prepared with the process parameters indicated in Table 1.

TABLE 1

| | Carbon black pellets | Carbon black pellets | Carbon black pellets |
|---|---|---|---|
| | in accordance with | in accordance with | in accordance with |
| Parameter | the invention 2 | the invention 3 | the invention 4 |
| Spray angle | 45° | 45° | 45° |
| Water pressure at spray | 3.5 bar | 3.5 bar | 3.5 bar |
| nozzles | | | |
| Moisture content of | 53 wt % | 53 wt % | 37 wt % |
| resulting carbon black | | | |
| pellets | | | |
| Molasses concentration in | 20 wt % | 20 wt % | 20 wt % |
| supply tank | | | |
| Molasses concentration in | 1.5 wt % | 1 wt % | 2 wt % |
| pelletizing water | | | |
| Drier temperature | 175° C. | 175° C. | 180° C. |

To produce the carbon black pellets in accordance with the invention the inlet nozzles for the pelletizing water are positioned as close as possible to the carbon black inlet in the RMG 600 WL in order to obtain an optimum granulation action over the remaining length of the RMG 600 WL. Two nozzle holders with two spray nozzles each are used. The direction of spray of the nozzles has an angle of 45° to and in the direction of the flow of the carbon black. The water pressure at the spray nozzles is kept constant at 3.5 bar, resulting in a moisture content in the undried carbon black pellets of 35-60 wt % 20% aqueous molasses from the company France Melasses S. A., Paris, is used as binder, which is diluted from a supply tank to the concentrations of 1-4 wt %. The feed tank, from which the unpelletized carbon black is supplied, must be kept constantly full in order to achieve a constant feed in the RMG 600. The carbon black pellets are then dried.

The analytical properties of the dried carbon black pellets are listed in Tables 2 and 3.

TABLE 2
Analytical data

| | | | Oil absorption | Individual | Individual |
|---|---|---|---|---|---|
| | | | number of the | pellet | pellet |
| | BET | Oil absorption | pressed | hardness | hardness |
| | surface | number | carbon black | (0.71-1 mm) | (1.4-1.7 mm) |
| | (m²/g) | (ml/100 g) | (ml/100 g) | (g) | (g) |
| Comparison | 41 | 121 | 88 | 13.6 | 30 |
| carbon black | | | | | |
| pellets 1 | | | | | |
| Carbon black | 42 | 121 | 88 | 10.3 | 22 |
| pellets in | | | | | |
| accordance with | | | | | |
| the invention 2 | | | | | |
| Carbon black | 41 | 123 | 89 | 7.8 | 16 |
| pellets in | | | | | |
| accordance with | | | | | |
| the invention 3 | | | | | |
| Carbon black | 32 | 65 | 60 | 14.0 | 25 |
| pellets in | | | | | |
| accordance with | | | | | |
| the invention 4 | | | | | |
| Comparison | 31 | 65 | 59 | 13.8 | 35 |
| carbon black | | | | | |
| pellets 5 | | | | | |

TABLE 3
Pellet size distribution

| | | Carbon black | Carbon black | Carbon black | |
|---|---|---|---|---|---|
| | Comparison | pellets in | pellets in | pellets in | |
| | carbon | accordance | accordance | accordance | Comparison |
| | black | with the | with the | with the | carbon black |
| | pellets 1 | invention 2 | invention 3 | invention 4 | pellets 5 |
| Pellet fraction | (wt %) | (wt %) | (wt %) | (wt %) | (wt %) |
| <0.125 mm | 2.9 | 0.5 | 0.3 | 3.7 | 1.4 |
| 0.125-0.25 mm | 2.9 | 0.8 | 0.6 | 9 | 6.2 |
| 0.25-0.20 mm | 6.4 | 4.8 | 6.1 | 23.7 | 22.4 |
| 0.50-0.71 mm | 8 | 10 | 13.7 | 21.9 | 22.5 |
| 0.71-1.0 mm | 19 | 27.6 | 34.9 | 24.2 | 30.8 |
| 1.0-1.5 mm | 37.1 | 44.2 | 39.1 | 14.7 | 14.8 |
| 1.5-2.0 mm | 12.5 | 8.9 | 3.9 | 1.6 | 0.8 |
| 2.0-2.5 mm | 7.7 | 2.8 | 1.2 | 0.6 | 0.4 |
| >2.5 mm | 3.5 | 0.4 | 0.2 | 0.6 | 0.7 |

The analytical data for the carbon black pellets are determined as according to the following standards:

BET surface ASTM 6556-01a,

Oil absorption number: ASTM D-2414-01,

Oil absorption number of the pressed carbon black ASTM D-3493-01

Individual pellet hardness ASTM D-3313-99,

Fine fraction: ASTM D-1508-01

The pellet size distribution is determined in the teaching of ASTM D 1511-00. A Ro-Tap licensed from the WS Tyler firm is used as sieve shaker. In a departure from the said standard a sieve cascade with sieves of 0.125 mm, 0.25 mm, 0.5 mm, 0.71 mm, 1.00 mm, 1.5 mm, 2.0 mm and 2.5 mm is used. These numerical values indicate the clear mesh widths of the sieves.

Paraffin oil from the Exxon Company, Marcol 82, is used to determine the oil absorption number and the oil absorption number of the pressed carbon black.

### EXAMPLE 2

Conveying Properties:

The transport properties of carbon black pellets are tested in a pilot plant. The tubes are lined with a rubber hose to minimize adhesion of the transported material to the tube walls. The carbon black pellets are circulated with a total transport length of 64 m, including 12 m vertical transport and seven turns. The tube diameter is 100 mm over most of the transport length and 110 mm in the last 14 m. The carbon black pellets are fed from the supply vessel into the transport system by means of a star wheel gate. At the end of the transport system there is a receiving tank for the transported carbon black.

The carbon black pellets from Tables 2 and 3 are tested.

The results of the dense flow transport test show that with the carbon black pellets 2 in accordance with the invention the course of pressure over time is constant or produces a plateau (FIG. 2). The air velocity can be reduced to 5.6 m/sec without variations in the pressure course occurring. A high solids/transport air ratio of 20 kg/kg and a transport power of 4.6 ton/h is achieved.

The left-hand axis of FIGS. 2-10 gives the weight of the carbon black transported into the receiving tank (in kg). The right hand axis gives the transport pressure (in bars for the absolute pressure). This means, for example, that at 1.5 bar the overpressure in the conduit is 0.5 bar.

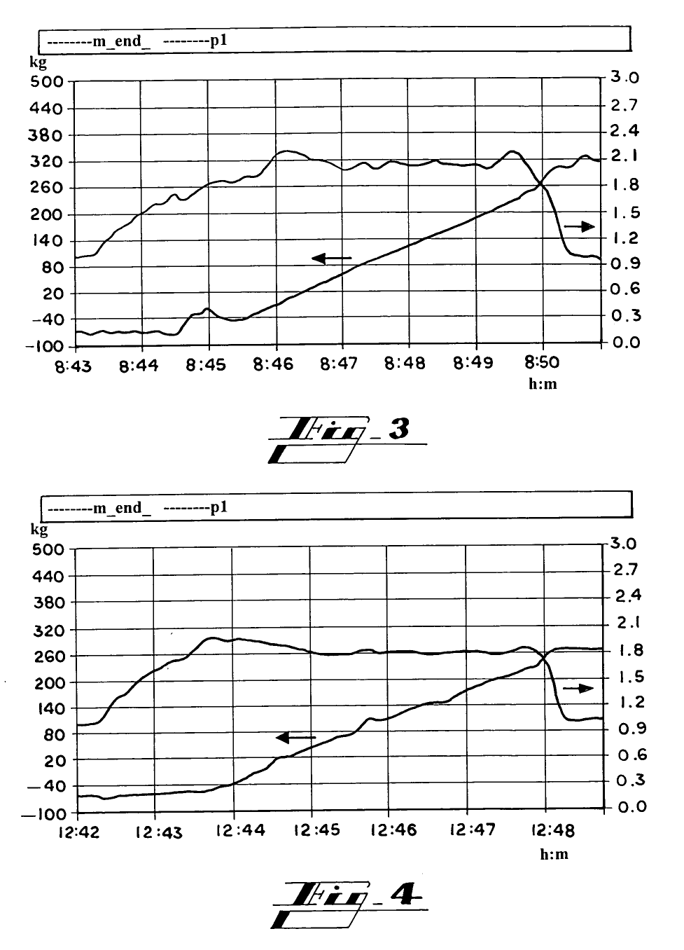

Although with the comparison carbon black 1 the solids/air ratio is lowered to 14 kg/kg, one can see a clearly unsteady pressure course over time (FIG. 3), so that the air velocity of 6.6 m/sec cannot be reduced further without there being the danger of transport problems. Uneven transport up to plugging of the transport conduits can occur. The transport amount of the comparison carbon black pellets 1 is therefore limited to 3.8 ton/h.

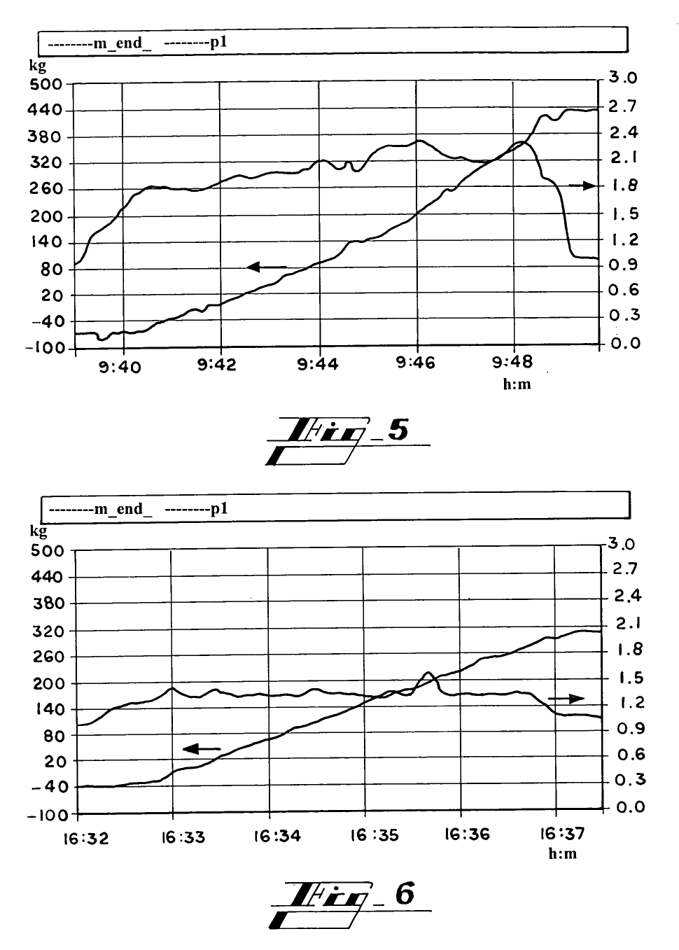

In the case of dense flow transport a comparison shows that the carbon black pellets 2 in accordance with the invention (FIG. 4) form a plateau of pressure in the pressure-time diagram at an air velocity of 4.8 m/sec even with an elevated solids/air ratio in comparison with the comparison carbon black pellets 1 (FIG. 5), and therefore produce stable transport conditions.

The comparison carbon black pellets 1, in spite of the reduced solids/air ratio, already show significant variations in the pressure course over time connected with increasing pressure, which confirms that a further decrease of the transport rate for these pellets is not possible without there being a clear increase of the danger of transport problems.

With the comparison carbon black pellets 1 and the carbon black pellets 2 in accordance with the invention under the said conditions 4 t/h are transported, but one can clearly see that the transport amount has to be reduced for the comparison pellets 1 in order to achieve permanently stable transport conditions.

For nearly the same transport air velocities (about 5.5 m/sec; FIGS. 2 and 5) higher solids/air ratio is possible with the carbon black pellets 2 in accordance with the invention than with the comparison pellets 1, which already show a very uneven course of pressure over time at the solids/air ratio of 18 kg/kg, so that all in all a higher transport capacity can be achieved with the carbon black pellets 2 in accordance with the invention.

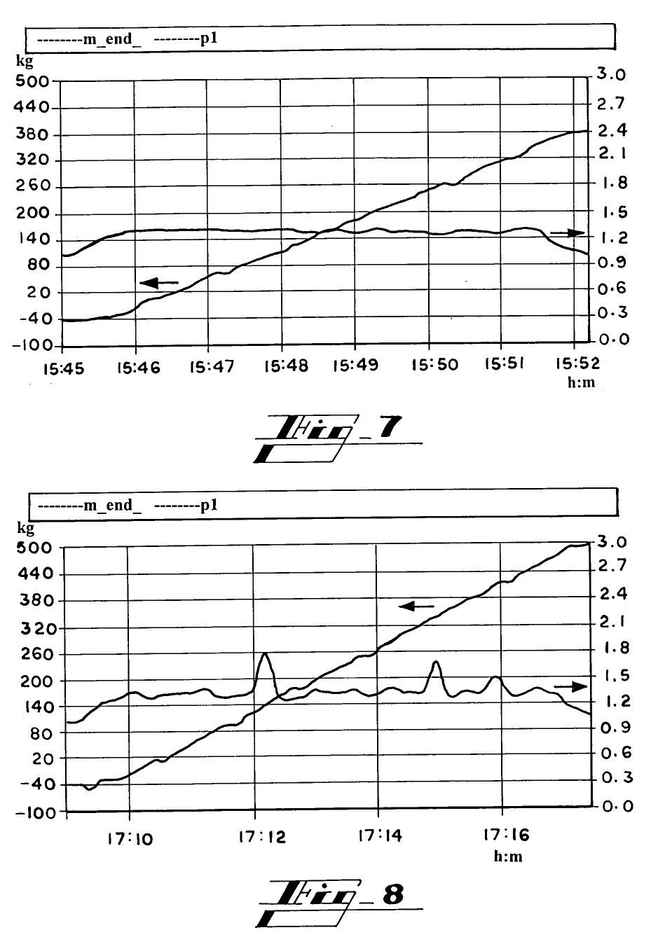

In the case of thin-stream transport it turns out that the comparison carbon black pellets 1 and the carbon black pellets 2 in accordance with the invention can be stably transported because of the increased transport air velocity (FIGS. 6 and 7). The carbon black pellets 2 in accordance with the invention can be transported with a slightly elevated solids/air ratio over the comparison carbon black pellets 1, so that all in all a higher transport capacity can be achieved. With the carbon black pellets 2 in accordance with the invention a fines fraction of 15 wt % formed after transport, which is clearly lower than the fine fraction of the comparison pellet 1, which was over 20 wt %. The carbon black pellets 2 in accordance with the invention are thus more easily dispersed. The good dispersibility is enhanced further through the low individual pellet hardness of the carbon black pellets 2 in accordance with the invention. The individual pellet hardness of the 1.4-1.7 mm fraction is only 22 g for the pellets in accordance with the invention, while the comparison pellets 1 have an individual pellet hardness of 30 g in this fraction.

The carbon black pellets 2 (FIG. 6) and 3 (FIG. 8) in accordance with the invention, which have a very similar pellet spectrum but different pellet hardnesses are compared in the thin flow transport. It turns out that the carbon black pellets 3 in accordance with the invention with individual pellet hardness of 16 g (1.4-1.7 mm) after transport have a fines fraction of 20 wt % and the pellets 2 in accordance with the invention, with an individual pellet hardness of 22 g (1.4-1.7 mm) have a fines fraction of only 15 wt % under these transport conditions.

The carbon black pellets 3 in accordance with the invention, in contrast to the comparison carbon black pellets 1, have a narrower pellet distribution with very low individual pellet hardness, which is advantageous for dispersion. In spite of the clearly different individual pellet hardnesses the carbon black pellets 3 in accordance with the invention (FIG. 8) after thin-stream transport, even at a higher solids/air ratio and thus higher transport amount, show a fines fraction of 20 wt %, while the comparison pellets 1 (FIG. 7), with a fines fraction of 21 wt %, have a clearly higher value, while the transport capacity is reduced at the same time.

The carbon black pellets 4 in accordance with the invention and the comparison carbon black pellets 5 had different colloidal properties than the blacks listed above. In contrast to the blacks considered above they have lower surface and lower structure.

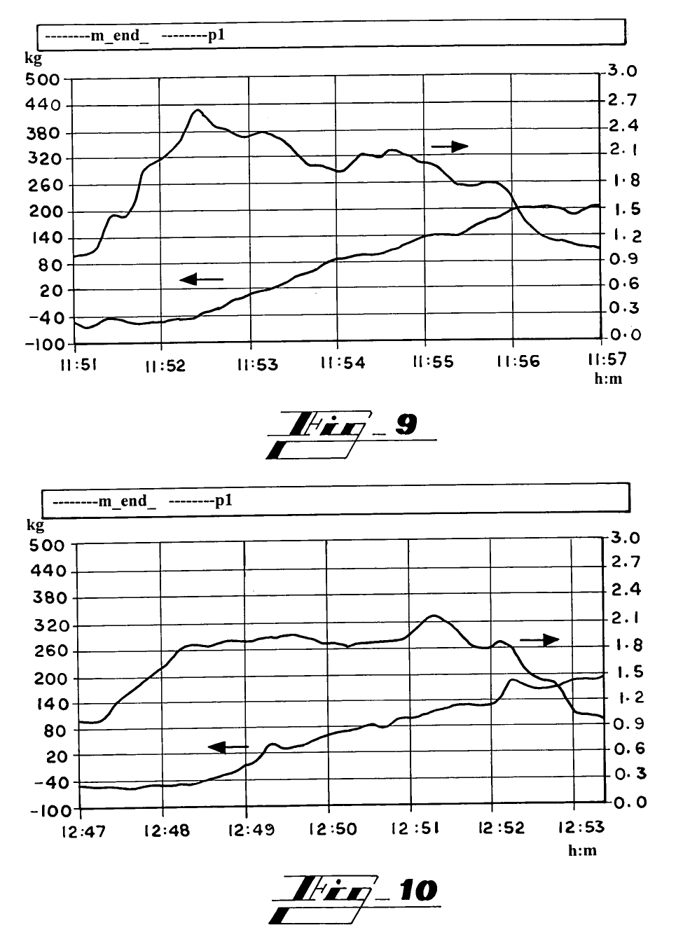

FIGS. 9 and 10 show the results of the two carbon black pellets for different air velocities in the thin stream process. The carbon black pellets 4 in accordance with the invention can still be quite stably transported at a transport air velocity of 5.8 m/sec and a solids/air ratio of 14 kg/kg, as can be seen from the plateau-like course of pressure over time (FIG. 10). From this results a transport capacity of 3.2 ton per hour. The comparison carbon black pellets 5 cannot be stably transported even at the higher air velocity of 7.0 m/sec and a solids/air ratio reduced to 11 kg/kg, as can be seen from the unstable course of pressure over time (FIG. 9). The resulting transport capacity is 3.1 t/h, but probably cannot be achieved in practice, since pluggings will occur. At the same time, the comparison carbon black pellets 5 have a fines fraction of 15 wt % after transport and therefore would present problems in other transport devices and in dispersion in other media, while the carbon black pellets 4 in accordance with the invention have a fines fraction of only 7 wt % after transport and therefore have better dispersion and transport properties.

Further variations and modifications of the foregoing will be apparent to those skilled in the art and are intended to be encompassed by the claims appended hereto.

German prior application 103 09 957.3 of Mar. 7, 2003, is relied on and incorporated herein by reference.

We claim:

1. A method for producing carbon black pellets, comprising feeding an amount of unpelletized carbon black as a feed amount into an inlet of a ring layer mixing granulator, keeping the feed amount of unpelletized carbon black constant and dispersing water into said granulator via two nozzle holders positioned as close as possible to the inlet, each with two nozzles, where spray cones from the nozzles make an angle between 10 and 90° to the direction of flow of the carbon black, at a pressure of 3-5 bar measured at the nozzles.

2. Carbon black pellets with an oil absorption number greater than 100 ml/100 g and an oil absorption number of the pressed carbon black greater than 78 ml/100 g, which are characterized by the fact that the pellet fraction with a diameter greater than 2.5 mm is less than 3.5 wt %, the pellet fraction with a diameter of 0.71-1.0 mm is greater than 22 wt %, and the individual pellet hardness of the fraction with the 0.71-1.0 mm diameter is between 7.0 and 25.0 g.

3. Carbon black pellets according to claim 2 which have a BET surface area of less than 70 m²/g.

4. Carbon black pellets according to claim 2 which in an undried state have a moisture content of 35 to 60 wt %.

5. Carbon black pellets with an oil absorption number less than 90 ml/100 g, and an oil absorption number of the pressed carbon black less than 78 ml/100 g, which are characterized by the fact that the pellet fraction with a diameter of 0.71-1.0 mm is less than 30 wt % and the individual pellet hardness of the fraction with the 0.71-1.0 mm diameter is between 7.0 and 25.0 g.

6. Carbon black pellets according to claim 5 which have a BET surface area of less than 70 m²/g.

7. Carbon black pellets according to claim 5 which in an undried state have a moisture content of 35 to 60 wt %.

8. A composition of matter comprising the carbon black pellets of claim 2 and a polymer, paint, dye or pigment.

9. A composition of matter comprising the carbon black pellets of claim 5 and a polymer, paint, dye or pigment.

10. A rubber composition comprising the carbon black pellets of claim 2 and a natural or synthetic rubber.

11. A rubber composition comprising the carbon black pellets of claim 5 and a natural or synthetic rubber.

12. A method of forming an unvulcanized rubber composition comprising:
mixing together the carbon black of claim 2 with a sufficient amount of a natural or synthetic rubber in a thermomechanical mixing step at a temperature of 100 to 170° C.

13. The method according to claim 12, further comprising subsequently adding crosslinking agents and mixing in an internal mixer or roll at 40 to 100° C.

14. The method according to claim 13, further comprising subsequently vulcanizing said rubber composition at 80 to 220° C., optionally under a pressure of 10-200 bar.

15. A method of forming an unvulcanized rubber composition comprising:
mixing together the carbon black of claim 5 with a sufficient amount of a natural or synthetic rubber in a thermomechanical mixing step at a temperature of 100 to 170° C.

16. The method according to claim 15, further comprising subsequently adding crosslinking agents and mixing in an internal mixture or role at 40 to 100° C.

17. The method according to claim 16, further comprising subsequently vulcanizing said rubber composition at 80 to 220° C., optionally under a pressure of 10-200 bar.

18. A vulcanized rubber article made from the rubber composition of claim 10.

19. A vulcanized rubber article made from the rubber composition of claim 11.

20. The vulcanized rubber article of claim 18 which is a tire, tire tread, cable jacket, hose, drive belt, conveyor belt, roll coating, shoe sole or sealing ring.

21. The vulcanized rubber article of claim 19 which is a tire, tire tread, cable jacket, hose, drive belt, conveyor belt, roll coating, shoe sole or sealing ring.
